(19) United States
(12) Patent Application Publication
(10) Pub. No.: US 2017/0295427 A1
(43) Pub. Date: Oct. 12, 2017

(54) EARSET AND CONTROL METHOD THEREFOR

(71) Applicant: Haebora Co., Ltd., Seoul (KR)

(72) Inventor: Doo Sik SHIN, Seoul (KR)

(21) Appl. No.: 15/511,681

(22) PCT Filed: Sep. 16, 2015
(86) PCT No.: PCT/KR2015/009731

§ 371 Date: Mar. 16, 2017

(30) Foreign Application Priority Data
Sep. 17, 2014 (KR) 10-2014-0123607

(51) Int. Cl. H04R 3/02; H04R 1/10; G10L 21/0216

(52) U.S. Cl. CPC H04R 3/02; G10L 21/0216; H04R 1/1083; H04R 1/1041; G10L 2021/02082

(57) ABSTRACT

Disclosed herein are an earset capable of reducing an interference due to communication and a method of controlling the same.

A method of controlling an earset including a first earphone unit including a first microphone and a first speaker and inserted into a user's ear and a main body connected to the first earphone unit and having a communicating unit provided therein according to an embodiment includes receiving, by an acoustic echo canceller of the communicating unit, parameter values required in cancelling an acoustic echo from a voice signal input to the first microphone, saving the received parameter values, and, on the basis of the saved parameter values, cancelling an acoustic echo from the voice signal input to the first microphone.

### TECHNICAL FIELD

Disclosed herein are an earset and a method of controlling the same.

### BACKGROUND ART

The use of an earset is increasing with increasing use of mobile phones. An earset refers to a device having a microphone and a speaker installed therein. Because hands are free when an earset is used, multitasking is possible while on the phone.

However, in a conventional earset, only a speaker is disposed inside a user's ear and a microphone is disposed outside the ear. Consequently, ambient noise is input to the microphone while using the phone, and call quality is degraded. To overcome the problem, an earset including an ear insertion type microphone, in which both a speaker and a microphone are disposed inside an ear so that a voice signal coming out at a user's ear is input to the microphone, has been developed.

However, even when talking on the phone with a called party using the above type of earset, an acoustic echo or a howling phenomenon may occur due to the structure of the earset in which the speaker and the microphone are arranged to be adjacent to each other or a communication means between the earset and a mobile phone.

### RELATED ART DOCUMENT

### Patent Document

Korean Patent Registration No. 10-1092958 (Title of Invention: Earset, Registration date: Dec. 6, 2011)

### DISCLOSURE

### Technical Problem

The present invention is directed to providing an earset capable of obtaining excellent call quality even when an earset in which a microphone and a speaker are arranged to be adjacent to each other communicates with an external device according to a communication means, and a method of controlling the same.

### Technical Solution

To achieve the above aspect, a method of controlling an earset including a first earphone unit including a first microphone and a first speaker and inserted into a user's ear and a main body connected to the first earphone unit and having a communicating unit provided therein according to an embodiment includes receiving, by an acoustic echo canceller of the communicating unit, parameter values required for cancelling an acoustic echo from a voice signal input to the first microphone, saving the received parameter values, and, on the basis of the saved parameter values, cancelling an acoustic echo from the voice signal input to the first microphone.

The parameter values may include one or more of a reference delay value which is a voice delay time in which the first speaker is coupled to the acoustic echo canceller and a low volume threshold value which is a size of a volume at which the acoustic echo canceller is operated.

The reference delay value may be set as 5 to 10 msec.

The reference delay value may be set as 7 msec or 8 msec.

The low volume threshold value may be set as −45 to 30 dB.

The low volume threshold value may be set as −45 dB, −42 dB, −39 dB, −36 dB, −33 dB, or −30 dB.

To achieve the above aspect, an earset according to an embodiment includes a first earphone unit including a first microphone and a first speaker and inserted into a user's ear and a communicating unit configured to process a voice signal input to the first microphone and transmit the processed voice signal to an external device or process a voice signal received from the external device and output the processed voice signal through the first speaker, wherein an acoustic echo canceller of the communicating unit cancels an acoustic echo from the voice signal input to the first microphone on the basis of preset parameter values, and the parameter values may include one or more of a reference delay value which is a voice delay time in which the first speaker is coupled to the acoustic echo canceller and a low volume threshold value which is a size of a volume at which the acoustic echo canceller is operated.

The reference delay value may be set as 5 to 10 msec.

The reference delay value may be set as 7 msec or 8 msec.

The low volume threshold value may be set as −45 dB, −42 dB, −39 dB, −36 dB, −33 dB, or −30 dB.

### Advantageous Effects

When an earset in which a microphone and a speaker are arranged to be adjacent to each other communicates with an external device according to a communication means, call quality can be improved by setting parameters of the earset such that quality degradation of a voice signal due to the structure of the earset in which the microphone and the speaker are arranged to be adjacent to each other and/or communication between the earset and the external device is minimized.

### DESCRIPTION OF DRAWINGS

FIG. 1 is a view illustrating a configuration of an earset system according to an embodiment.

FIG. 2 is a view illustrating a configuration of an earset according to an embodiment.

FIG. 3 is a view illustrating a configuration of an earset according to another embodiment.

FIG. 4 is a view illustrating a configuration of a communicating unit of FIGS. 2 and 3.

FIG. 5 is a view illustrating a method of controlling an earset according to an embodiment.

### MODES OF THE INVENTION

Advantages and features of the present invention and methods of achieving the same will become apparent by referring to embodiments that will be described in detail below with reference to the accompanying drawings. However, the present invention is not limited to the embodiments that will be described below and may be realized in other various forms. The embodiments are merely provided to make the present invention complete and to thoroughly inform one of ordinary skill in the art to which the present invention pertains of the scope of the present invention, and the present invention is defined only by the scope of the claims.

Unless otherwise defined, all terms used herein (including technical or scientific terms) have the same meaning as commonly understood by one of ordinary skill in the art to which the present invention pertains. Also, terms defined in commonly used dictionaries should not be construed in an idealized or overly formal sense unless expressly so defined herein.

Terms used herein are merely used to describe particular embodiments and are not intended to limit the present invention. In the present specification, a singular expression includes a plural expression unless the context clearly indicates otherwise. Terms such as “comprises” and/or “comprising” used herein do not preclude the existence of or the possibility of adding one or more other elements besides those that are mentioned.

Hereinafter, embodiments of the present invention will be described with reference to the accompanying drawings. Like reference numerals represent like elements throughout the drawings.

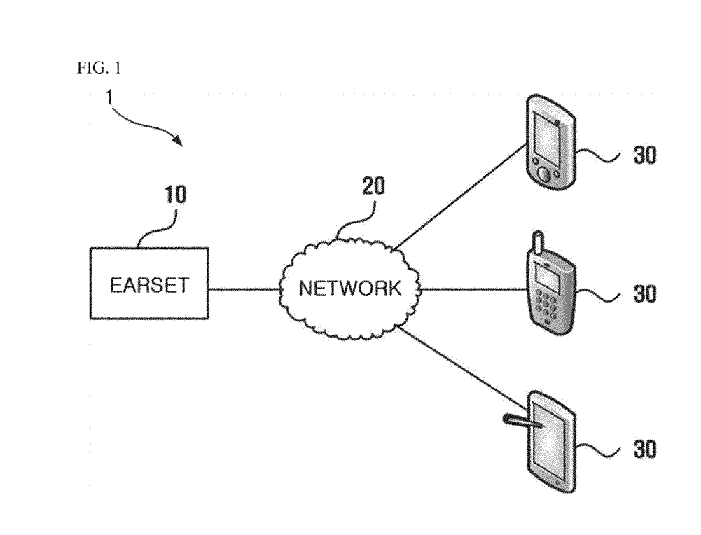

FIG. 1 is a view illustrating a configuration of an earset system according to an embodiment.

Referring to FIG. 1, an earset system 1 may include an earset 10 and an external device 30.

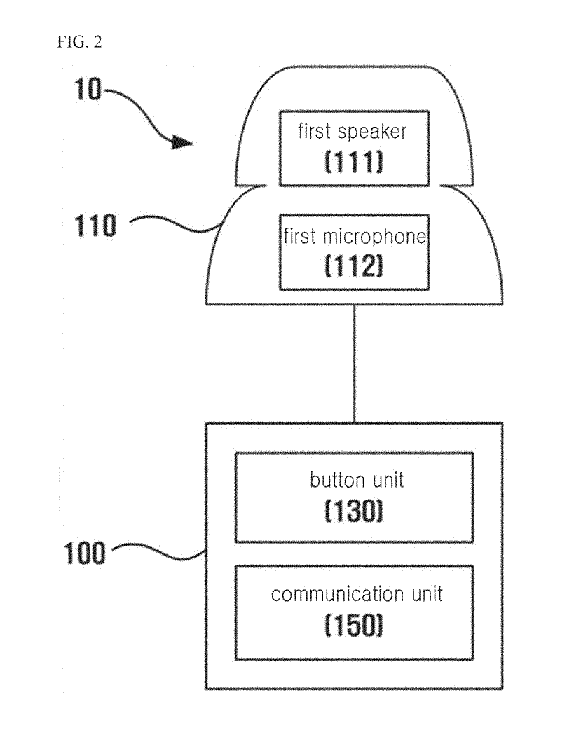

The earset 10 is a device inserted into a user's ear. The earset 10 may receive an acoustic signal or a voice signal from the external device 30 through a network 20. The network 20 may be a wired network or a wireless network. The configuration of the earset 10 will be described in more detail with reference to FIGS. 2 to 4.

The external device 30 transmits an acoustic signal or a voice signal to the earset 10 through the network 20 and receives a voice signal from the earset 10. For example, a wired communication means may be used between the external device 30 and the earset 10. In this case, the external device 30 and the earset 10 may be connected via a cable (not illustrated). In another example, one or more wireless communication means among ultra-wide band, ZigBee, wireless fidelity (Wi-Fi), and Bluetooth may be used between the external device 30 and the earset 10. In the description below, a case in which Bluetooth is used as a wireless communication means will be described as an example.

Meanwhile, when the external device 30 and the earset 10 communicate according to a wireless communication means, a pairing process may be performed between the external device30 and the earset 10 in advance. Pairing refers to a process of registering device information of the earset 10 in the external device 30 and registering device information of the external device 30 in the earset 10. When a signal is transmitted or received with the pair process completed, security of the transmitted or received signal may be maintained. The pairing process is not performed when the external device 30 and the earset 10 communicate according to a wired communication means, i.e., when the external device 30 and the earset 10 are connected via the cable (not illustrated).

The external device 30 may include wired and wireless communication devices. Examples of wired and wireless communication devices may include mobile terminals such as a palm personal computer (PC), a personal digital assistant (PDA), a wireless application protocol (WAP) phone, a smartphone, a smart pad, and a mobile playstation. The external device 30 whose examples have been given above may be a wearable device that may be worn on a unit of a user's body, e.g., head, wrist, finger, arm, or waist.

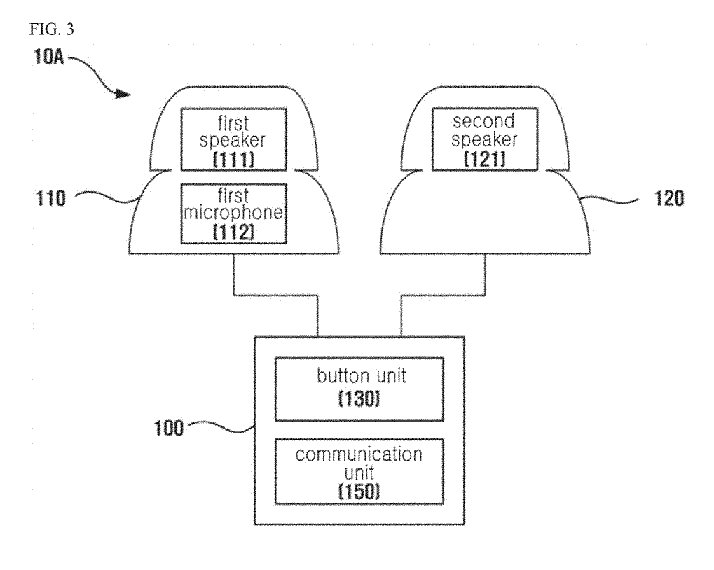

FIG. 2 is a view illustrating a configuration of an earset 10 according to an embodiment, FIG. 3 is a view illustrating a configuration of an earset 10 according to another embodiment.

First, referring to FIG. 2, an earset 10 according to an embodiment includes a first earphone unit 110 and a main body 100.

The first earphone unit 110 includes a first speaker 111 and a first microphone 112. The first earphone unit 110 is inserted into a first external auditory meatus (an external auditory meatus of the left ear) or a second external auditory meatus (an external auditory meatus of the right ear) of a user. The shape of the first earphone unit 110 may have a shape corresponding to that of the first external auditory meatus or a shape corresponding to that of the second external auditory meatus. Alternatively, the first earphone unit 110 may have any shape capable of being inserted into an ear regardless of the shape of the first external auditory meatus or the shape of the second external auditory meatus.

The first speaker 111 outputs an acoustic signal or a voice signal received from the external device 30. The output signal is transmitted to an eardrum along an external auditory meatus. The first microphone 112 receives a voice signal coming out at a user's ear. The voice signal input to the first microphone 112 is processed in a communicating unit 150 that will be described below and transmitted to the external device 30. When both of the first speaker 111 and the first microphone 112 are arranged in the first earphone unit 110 as described above, external noise may be prevented from being input into the first microphone 112.

Meanwhile, as illustrated in FIG. 3, an earset 10A may include the first earphone unit 110 and a second earphone unit 120. That is, compared to the earset 10 illustrated in FIG. 2 including only the first earphone unit 110, the earset 10A illustrate in FIG. 3 further includes the second earphone unit 120.

Referring to FIG. 3, compared to the first earphone unit 110 including the first speaker 111 and the first microphone 112, the second earphone unit 120 may include only a second speaker 121. The second earphone unit 120 is inserted into the second external auditory meatus (an external auditory meatus of the left ear) of the user. For example, an outer shape of the first earphone unit 110 and an outer shape of the second earphone unit 120 may be differentiated from each other. That is, the first earphone unit 110 and the second earphone unit 120 may respectively have shapes corresponding to the shape of the first external auditory meatus and the shape of the second external auditory meatus. In another example, the outer shape of the first earphone unit 110 and the outer shape of the second earphone unit 120 may not be differentiated from each other and may be the same.

Referring again to FIG. 2, the main body 100 is electrically connected to the first earphone unit 110. Compared to the first earphone unit 110 being inserted into an ear, the main body 100 may be exposed outside a user's ear. The main body 100 processes a voice signal input to the first microphone 112 and transmits the processed voice signal to the external device 30. Also, the main body 100 processes a voice signal received from the external device 30 and outputs the processed voice signal to the first speaker 111. For this, the main body 100 may include a button unit 130 and the communicating unit 150.

The button unit 130 may include buttons capable of receiving commands required to operate the earset 10. For example, the button unit 130 may include a power button configured to supply power to the earset 10 and a pairing execution button configured to execute a pairing operation with the external device 30.

The buttons listed above as examples may be realized using separate buttons in a hardware form or may be realized using a single button in a hardware form. When the buttons listed above as examples are realized using a single button in the hardware form, different commands may be input according to a button manipulation pattern. Although buttons disposed in the button unit 130 have been described above, the buttons listed above as examples are not necessarily disposed in the button unit 130, and the number or types of buttons included in the button unit 130 may differ according to circumstances.

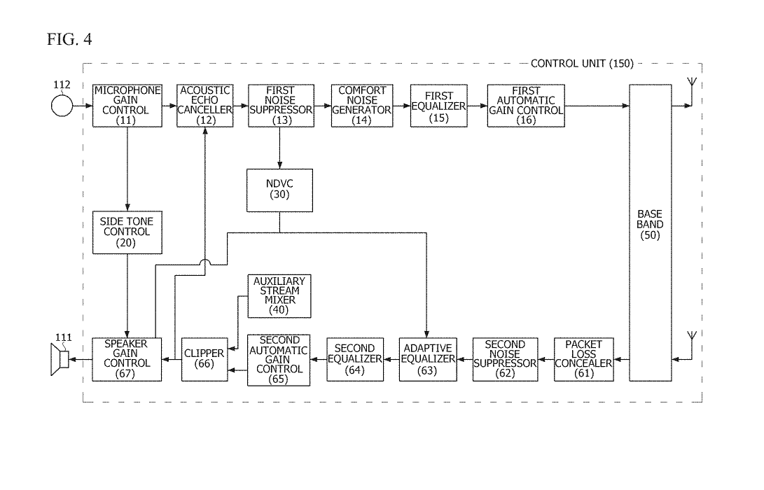

The communicating unit 150 may transmit and receive a control signal required for a pairing process between the earset 10 and the external device 30. Moreover, the communicating unit 150 may process a voice signal input to the first microphone 112 and transmit the processed voice signal to the external device 30 or process a voice signal received from the external device 30 and output the processed voice signal through the first speaker 111. Here, the communicating unit 150 may process a voice signal on the basis of a preset parameter value. Here, FIG. 4 will be referred to for describing the communicating unit 150 in more detail.

Referring to FIG. 4, the communicating unit 150 may include a microphone gain control 11, an acoustic echo canceller 12, a first noise suppressor 13, a comfort noise generator 14, a first equalizer 15, a first automatic gain control 16, a side tone control 20, a noise-dependent volume control (NDVC) 30, an auxiliary stream mixer 40, a baseband 50, a packet loss concealer 61, a second noise suppressor 62, an adaptive equalizer 63, a second equalizer 64, a second automatic gain control 65, a clipper 66, and a speaker gain control 67.

The microphone gain control 11 controls gain of a voice signal input to the first microphone 112.

The acoustic echo canceller 12 cancels an acoustic echo according to a preset parameter value. As described above, because the first speaker 111 and the first microphone 112 are installed in the first earphone unit 110, an acoustic echo phenomenon in which sound output through the first speaker 111 is input again to the first microphone 112 may occur. Consequently, a voice signal output from the first speaker 111 needs to be cancelled from a voice signal input to the first microphone 112. The acoustic echo canceller 12 may cancel an acoustic echo according to a preset parameter value.

A reference delay value and a low volume threshold value may be given as examples of a parameter value required for cancelling an acoustic echo.

A reference delay value refers to a voice delay time in which the first speaker 111 is coupled to the acoustic echo canceller 12. According to an embodiment, the reference delay value may be set as 5 to 10 msec. Preferably, the reference delay value may be set as 7 msec or 8 msec.

A low volume threshold value refers to a size of a volume at which the acoustic echo canceller is operated. According to an embodiment, the low volume threshold value may be set as −45 to −30 dB. Preferably, the low volume threshold value may be set as −45 dB, −42 dB, −39 dB, −36 dB, −33 dB, or −30 dB.

When the reference delay value and the low volume threshold value are set as one of the values within the ranges given above as examples, compared to a case in which the reference delay value and the low volume threshold value are set as different values, an acoustic echo or howling due to the structure of the earset 10 in which the first speaker 111 and the first microphone 112 are arranged to be adjacent to each other and/or communication between the earset 10 and the external device 30 is reduced by 70%. Consequently, quality of a voice signal that will be transmitted to the external device 30 or a voice signal received from the external device 30 may be improved.

The first noise suppressor 13 suppresses noise from the voice signal output from the acoustic echo canceller 12. For this, the first noise suppressor 13 may include a filter (not illustrated).

The comfort noise generator 14 adds comfort noise to the voice signal from which noise is suppressed. When comfort noise is added to the voice signal as above, noise that is pleasing to a receiver's ear may be played when the user is silent.

The first equalizer 15 controls an overall frequency characteristic of the voice signal to which comfort noise is added.

The first automatic gain control 16 applies gain to the voice signal output from the first equalizer 15 and automatically controls the size of the voice signal.

That is, when the size of the voice signal output from the first equalizer 15 is small, the first automatic gain control 16 amplifies the size of the voice signal, and when the size of the voice signal output from the first equalizer 15 is large, the first automatic gain control 16 decreases the size of the voice signal. In this way, a voice signal having a predetermined size can be transmitted to the external device 30.

The side tone control 20 cancels side tone from a voice signal output from the microphone gain control 11.

The NDVC 30 controls a size of a voice signal received from the external device 30 on the basis of noise estimated in the first noise suppressor 13. That is, on the basis of noise estimated in the first noise suppressor 13, the NDVC 30 increases gain of a digital-analog converter and increases intelligibility of a voice signal received from the external device 30.

The baseband 50 may modulate a voice signal output from the first automatic gain control 16 or demodulate a voice signal received from the external device 30.

The packet loss concealer 61 restores a lost packet from a voice signal received from the external device 30. The voice signal in which the lost packet is restored is provided to the second noise suppressor 62.

The second noise suppressor 62 suppresses noise from the voice signal in which the lost packet is restored. For this, the second noise suppressor 62 may include a filter.

The adaptive equalizer 63 maintains an overall power level of the voice signal from which noise is suppressed by the second noise suppressor 62 and changes a spectrum shape of the corresponding voice signal to increase intelligibility of a voice signal in which near-end noise is present.

The second equalizer 64 controls an overall frequency characteristic of the voice signal output from the adaptive equalizer 63.

The second automatic gain control 65 applies gain to the voice signal output from the second equalizer 64 and automatically controls the size of the voice signal. That is, when the size of the voice signal output from the second equalizer 64 is small, the second automatic gain control 65 amplifies the size of the voice signal, and when the size of the voice signal output from the second equalizer 64 is large, the second automatic gain control 65 decreases the size of the voice signal. In this way, a voice signal having a predetermined size can be transmitted to the first speaker 111.

The auxiliary stream mixer 40 may mix voice signals such as tones, beeps, and voice prompts. Mixed voice signals are provided to the clipper.

The clipper 66 improves an echo by limiting an amplitude of a voice signal provided from the auxiliary stream mixer 40 and the voice signal provided from the second automatic gain control 65.

The speaker gain control 67 controls gain of the voice signal received from the clipper 66. The voice signal in which gain is controlled is output through the first speaker 111.

A configuration of the communicating unit 150 has been described above with reference to FIG. 4. Each of the elements of the communicating unit 150 may operate on the basis of a preset parameter value. A parameter for each of the elements may be set when, for example, manufacturing the earset 10.

Specifically, when a tester inputs a parameter setting start command to a test device (not illustrated) while the earset 10 is connected to the test device, a graphical user interface capable of setting various types of parameters related to the communicating unit 150 of the earset 10 is configured in the test device. The configured graphical user interface is displayed through a display of the test device. Then, the tester may set parameter values with respect to each of the elements of the communicating unit 150. For example, the tester may set parameter values required for the acoustic echo canceller 12 to cancel an acoustic echo from a voice signal. Examples of a parameter value required to cancel an acoustic echo may include a reference delay value and a low volume threshold value.

When a command for applying parameter values set through the graphical user interface to the earset 10 is input to the test device, the set parameter values may be saved in a memory (not illustrate) disposed in the earset 10. Then, by referring to the parameters saved in the memory, the communicating unit 150 of the earset 10 may process a voice signal that will be transmitted to the external device 30 or a voice signal received from the external device 30. When a voice signal is processed using the above method, degradation of call quality due to the structure of the earset 10 in which the first speaker 111 and the first microphone 112 are arranged to be adjacent to each other and/or communication between the external device 30 and the earset 10 may be minimized.

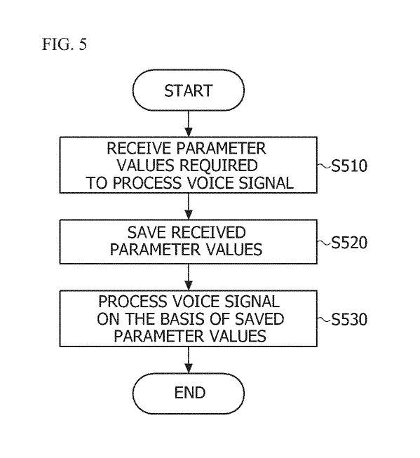

FIG. 5 is a view illustrating a method of controlling an earset according to an embodiment.

The method of controlling an earset according to an embodiment may include receiving, by the communicating unit 150 of the earset 10, parameter values required to process a voice signal (S510), saving the received parameter values (S520), and processing a voice signal on the basis of the saved parameter values (S530).

The parameter values may be received from a test device (not illustrate) connected to the earset 10.

Also, the receiving of the parameter values (S510) may include receiving, by the acoustic echo canceller 12 of the communicating unit 150, parameter values required to cancel an acoustic echo from a voice signal.

A reference delay value and a low volume threshold value may be given as examples of parameter values required for cancelling an acoustic echo from a voice signal. According to an embodiment, the reference delay value may be set as 5 to 10 msec. Preferably, the reference delay value may be set as 7 msec or 8 msec. The low volume threshold value may be set as −45 to −30 dB. Preferably, the low volume threshold value may be set as −45 dB, −42 dB, −39 dB, −36 dB, −33 dB, or −30 dB.

When the reference delay value and the low volume threshold value are set as one of the values within the ranges given above as examples, an acoustic echo or howling due to the structure of the earset 10 in which the first speaker 111 and the first microphone 112 are arranged to be adjacent to each other and/or a communication means between the earset 10 and the external device 30 is reduced. Consequently, quality of a voice signal can be prevented from being degraded even when the voice signal is transmitted or received according to a communication means between the earset 10 and the external device 30.

Embodiments of the present invention have been described above. In addition to the embodiments described above, embodiments of the present invention may also be realized using a medium including a computer readable code or an instruction for controlling at least one processing element of the embodiments described above, e.g., a computer readable medium. The medium may correspond to a medium or media that enables the computer readable code to be stored and/or transmitted.

The computer readable code may be recorded in a medium as well as transmitted through the Internet. The medium may include, for example, a recording medium such as a magnetic storage medium (e.g., a read-only memory (ROM), a floppy disk, a hard disk, etc.) and an optical recording medium (e.g., a compact disk (CD)-ROM, Blu-Ray, a digital versatile disk (DVD)) and a transmission medium such as a carrier wave. Because the media may be distributed networks, a computer readable code may be executed after being stored or transmitted in a distributed manner. Also, moreover, a processing element may include a processor or a computer processor merely as an example, and the processing element may be distributed and/or included in a single device.

Although embodiments of the present invention have been described above with reference to the accompanying drawings, one of ordinary skill in the art to which the present invention pertains should understand that the present invention may be performed in other specific forms without changing the technical spirit or essential features of the present invention. Thus, embodiments described above are illustrative in all aspects and should not be understood as limiting.

What is claimed is:

1. A method of controlling an earset including a first earphone unit including a first microphone and a first speaker and inserted into a user's ear and a main body connected to the first earphone unit and having a communicating unit provided therein, the method comprising:
receiving, by an acoustic echo canceller of the communicating unit, parameter values required in cancelling an acoustic echo from a voice signal input to the first microphone;
saving the received parameter values; and
on the basis of the saved parameter values, cancelling an acoustic echo from the voice signal input to the first microphone.

2. The method of claim 1, wherein the parameter values include at least one of a reference delay value which is a voice delay time in which the first speaker is coupled to the acoustic echo canceller and a low volume threshold value which is a size of a volume at which the acoustic echo canceller is operated.

3. The method of claim 2, wherein the reference delay value is set as 5 to 10 msec.

4. The method of claim 3, wherein the reference delay value is set as 7 msec or 8 msec.

5. The method of claim 2, wherein the low volume threshold value is set as −45 to −30 dB.

6. The method of claim 5, wherein the low volume threshold value is set as −45 dB, −42 dB, −39 dB, −36 dB, −33 dB, or −30 dB.

7. An earset comprising:
a first earphone unit including a first microphone and a first speaker and inserted into a user's ear; and
a communicating unit configured to process a voice signal input to the first microphone and transmit the processed voice signal to an external device or process a voice signal received from the external device and output the processed voice signal through the first speaker, wherein:
an acoustic echo canceller of the communicating unit cancels an acoustic echo from the voice signal input to the first microphone on the basis of preset parameter values; and
the parameter values include at least one of a reference delay value which is a voice delay time in which the first speaker is coupled to the acoustic echo canceller and a low volume threshold value which is a size of a volume at which the acoustic echo canceller is operated.

8. The earset of claim 7, wherein the reference delay value is set as 5 to 10 msec.

9. The earset of claim 8, wherein the reference delay value is set as 7 msec or 8 msec.

10. The earset of claim 7, wherein the low volume threshold value is set as −45 dB, −42 dB, −39 dB, −36 dB, −33 dB, or −30 dB.
